(19) United States
(12) Patent Application Publication
(10) Pub. No.: US 2012/0058849 A1
(43) Pub. Date: Mar. 8, 2012

(54) FRICTION DRIVE BELT AND MANUFACTURING METHOD THEREOF

(75) Inventor: Keisuke Yoshida, Hyogo (JP)

(73) Assignee: BANDO CHEMICAL INDUSTRIES, LTD, Hyogo (JP)

(21) Appl. No.: 13/321,259

(22) PCT Filed: May 11, 2010
(86) PCT No.: PCT/JP2010/003200

§ 371 Date: Nov. 18, 2011

(30) Foreign Application Priority Data
May 20, 2009 (JP) 2009-122065

(51) Int. Cl. F16G 1/08; F16H 7/02; B29C 43/20

(52) U.S. Cl. 474/148; 474/237; 264/112; 474/263

(57) ABSTRACT

In a friction drive belt (B), a belt body (10) made of a rubber composition is wrapped around pulleys to transmit power. A powder layer (16) is combined and integrated with a pulley contact-side surface of the belt body (10) located on a side that is to contact the pulleys, so that the powder layer (16) covers the pulley contact-side surface.

### TECHNICAL FIELD

The present invention relates to friction drive belts in which a belt body made of a rubber compound is wrapped around pulleys to transmit power, and manufacturing methods thereof, and belt transmission systems using the same.

### BACKGROUND ART

For friction drive belts such as a V-ribbed belt, various techniques have been proposed to reduce a slip noise or other noises that are generated on pulleys during running of a belt.

For example, Patent Document 1 discloses that powder such as talc is made to adhere to the surfaces of V-shaped ribs surface after vulcanization-molding a V-ribbed belt.

Patent Document 2 discloses that short fibers are provided so as to partially protrude from the surfaces of V-shaped ribs of a V-ribbed belt, and powder such as talc is made to adhere to the surfaces of V-shaped ribs so as to bury the protruding portions of the short fibers therein.

Patent Document 3 discloses that a V-ribbed belt having short fibers firmly adhering to the surfaces of V-shaped ribs is manufactured by applying an adhesive to the surface of a vulcanization-molded belt sleeve, and spraying short fibers thereto.

Patent Document 4 discloses that a V-ribbed belt having short fibers adhering to the surfaces of V-shaped ribs is manufactured by applying an adhesive to the inner peripheral surface of an outer mold which has a pattern of the V-shaped ribs formed thereon, and spraying short fibers to the inner peripheral surface of the outer mold, while placing an uncrosslinked rubber composition and a core wire on an inner mold.

### Citation List

### Patent Document

PATENT DOCUMENT 1: Japanese Patent Publication No. 2004-116755

PATENT DOCUMENT 2: Japanese Examined Utility Model Publication No. H07-31006

PATENT DOCUMENT 3: Japanese Patent Publication No. 2004-276581

PATENT DOCUMENT 4: Japanese Patent No. 4,071,131

### SUMMARY OF THE INVENTION

According to the present invention, a friction drive belt includes: a belt body that is made of a rubber composition and is wrapped around pulleys to transmit power; and a powder layer is combined and integrated with a pulley contact-side surface of the belt body, so that the powder layer covers the pulley contact-side surface.

According to the present invention, a friction drive belt includes: a belt body that is made of a rubber composition and is wrapped around pulleys to transmit power, wherein the friction drive belt is manufactured by providing a layer of powder by spraying, in advance, powder to a molding surface of a belt forming mold which is configured to form a pulley contact-side portion, pressing against the molding surface an uncrosslinked rubber composition configured to form the belt, and thus crosslinking the uncrosslinked rubber composition.

According to the present invention, a belt transmission system includes: the above friction drive belt wrapped around a plurality of pulleys.

According to the present invention, a method for manufacturing a friction drive belt includes: pressing an uncrosslinked rubber composition configured to form the belt, against a molding surface of a belt forming mold which is configured to form a pulley contact-side portion, and thus crosslinking the uncrosslinked rubber composition; and before pressing against the molding surface of the belt forming mold the uncrosslinked rubber composition configured to form the belt, providing a layer of powder by spraying, in advance, powder to the molding surface of the belt forming mold.

### BRIEF DESCRIPTION OF THE DRAWINGS

FIG. 1 is a perspective view of a V-ribbed belt according to an embodiment.

FIG. 2 is a cross-sectional view showing a main part of the V-ribbed belt according to the embodiment.

FIG. 3 is a cross-sectional view showing a main part of a modification of the V-ribbed belt according to the embodiment.

FIG. 4 is a diagram showing a layout of pulleys of an accessory drive belt transmission system of an automobile.

FIG. 5 is a longitudinal cross-sectional view showing a belt forming mold.

FIG. 6 is an enlarged longitudinal cross-sectional view showing a part of the belt forming mold.

FIG. 7 is an illustration showing the step of spraying powder to an outer mold.

FIG. 8 is an illustration showing the step of placing uncrosslinked rubber sheets and twisted yarns on an inner mold.

FIG. 9 is an illustration showing the step of positioning the inner mold in the outer mold.

FIG. 10 is an illustration showing the step of molding a belt slab.

FIG. 11 is a diagram showing a layout of pulleys of a belt running tester for a belt durability test.

FIG. 12 is a diagram showing a layout of pulleys of a belt running tester for a noise test during running of the belt.

### DESCRIPTION OF EMBODIMENTS

An embodiment will be described in detail below with reference to the accompanying drawings.

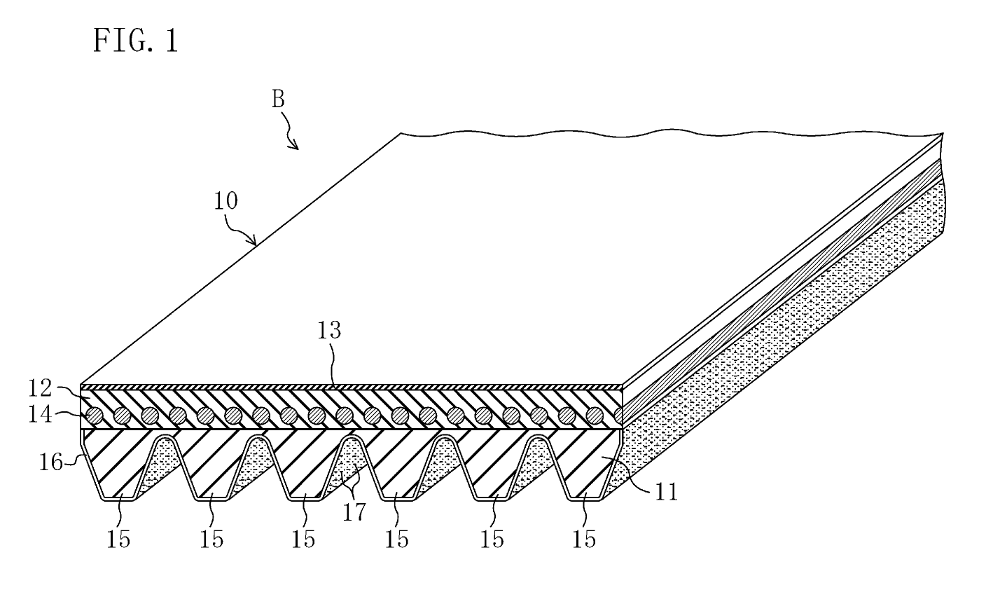

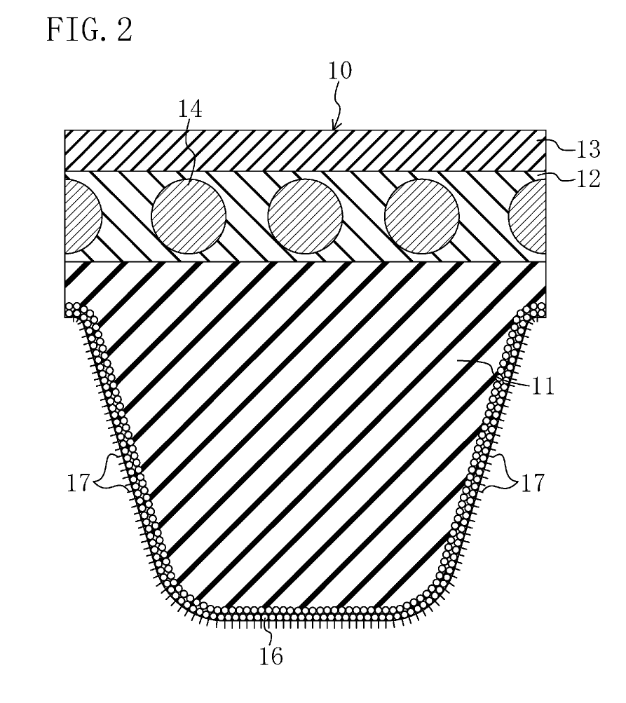

FIGS. 1-2 show a V-ribbed belt B (a friction drive belt) according to the present embodiment. The V-ribbed belt B of the present embodiment is used in, e.g., accessory drive belt transmission systems provided in engine compartments of automobiles. The V-ribbed belt B of the present embodiment has, e.g., a circumference of 700-3,000 mm, a width of 10-36 mm, and a thickness of 4.0-5.0 mm.

The V-ribbed belt B of the present embodiment includes a V-ribbed belt body 10 having a three-layer configuration of a compression rubber layer 11 on the inner side of the belt, an adhesion rubber layer 12 as an intermediate layer, and a backing rubber layer 13 on the outer side of the belt. A core wire 14 is embedded in the adhesion rubber layer 12 so as to form a helical pattern having a pitch in the lateral direction of the belt.

The compression rubber layer 11 is provided so that a plurality of V-shaped ribs 15 are tapered toward the inner side of the belt. Each of the plurality of V-shaped ribs 15 is formed in a ridge shape having a substantially inverted triangular cross section and extending in the longitudinal direction of the belt, and the plurality of V-shaped ribs 15 are arranged parallel to each other in the lateral direction of the belt. Each of the V-shaped ribs 15 has, e.g., a height of 2.0-3.0 mm, and a width of 1.0-3.6 mm at its base end. The number of ribs is, e.g., 3-6 (6 ribs in FIG. 1). The compression rubber layer 11 is made of a rubber composition produced by kneading a mixture of a rubber component and various compounding agents to form an uncrosslinked rubber composition, heating and pressing the uncrosslinked rubber composition, and crosslinking the uncrosslinked rubber composition by a crosslinker.

Examples of the rubber component of the rubber composition that forms the compression rubber layer 11 include ethylene-α-olefin elastomers, chloroprene rubber (CR), chlorosulfonated polyethylene rubber (CSM), hydrogenated acrylonitrile rubber (H-NBR), etc. The rubber component may be comprised of either a single substance or a mixture of a plurality of substances.

Examples of the compounding agents include a reinforcer such as carbon black, a vulcanization accelerator, a crosslinker, an antioxidant, a softener, etc.

Examples of carbon black as the reinforcer include channel black, furnace black such as SAF, ISAF, N-339, HAF, N-351, MAF, FEF, SRF, GPF, ECF, N-234, etc., thermal black such as FT, MT, etc., and acetylene black. Silica is another example of the reinforcer. The reinforcer may be comprised of either a single substance or a plurality of substances. Preferably, the amount of the reinforcer is 30-80 parts by mass per 100 parts by mass of the rubber component as a satisfactory balance is achieved between wear resistance and bending resistance.

Examples of the vulcanization accelerator include metal oxides such as magnesium oxide and zinc oxide (zinc flower), metal carbonates, fatty acids such as stearic acid, derivatives thereof, etc. The vulcanization accelerator may be comprised of either a single substance or a plurality of substances. For example, 0.5-8 parts by mass of the vulcanization accelerator is added per 100 parts by mass of the rubber component.

Examples of the crosslinker include sulfur, organic peroxides, etc. Sulfur, an organic peroxide, or a combination of sulfur and an organic peroxide may be used as the crosslinker. In the case of sulfur, 0.5-4.0 parts by mass of the crosslinker is preferably added per 100 parts by mass of the rubber component. In the case of the organic peroxide, e.g., 0.5-8 parts by mass of the crosslinker is added to 100 parts by mass of the rubber component.

Examples of the antioxidant include amines, quinolines, hydroquinone derivatives, phenols, and phosphites. The antioxidant may be comprised of either a single substance or a plurality of substances. For example, 0-8 parts by mass of the antioxidant is added per 100 parts by mass of the rubber component.

Examples of the softener include petroleum softeners, mineral oil softeners such as paraffin wax, and vegetable oil softeners such as castor oil, cottonseed oil, linseed oil, rapeseed oil, soybean oil, palm oil, coconut oil, peanut oil, haze wax, rosin, and pine oil. The softener may be comprised of either a single substance or a plurality of substances. Regarding the softeners other than the petroleum softeners, for example, 2-30 parts by mass of the softener is added per 100 parts by mass of the rubber component.

A layered silicate such as a smectite group, a vermiculite group, or a kaolin group may be included as the compounding agent.

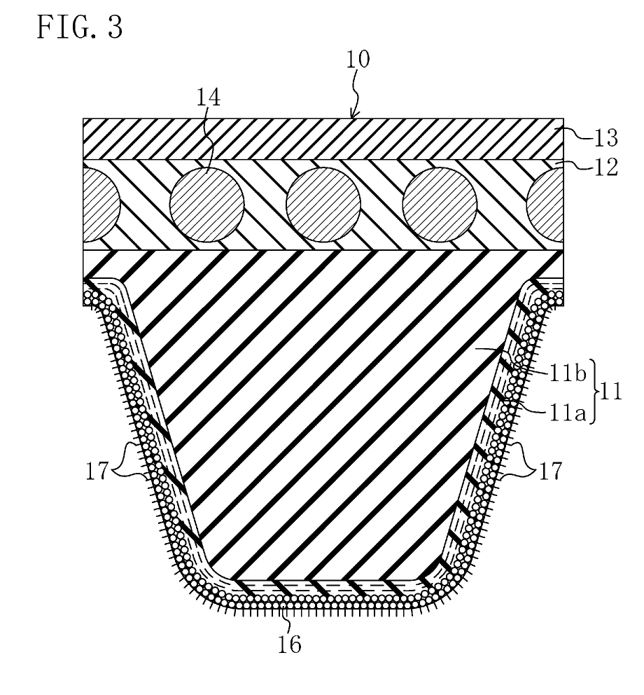

The compression rubber layer 11 may be comprised of either a single rubber composition or a stack of a plurality of rubber compositions. For example, as shown in FIG. 3, the compression rubber layer 11 may have a pulley contact-side surface layer 11a located on the side that is to contact pulleys and containing a material that reduces a friction coefficient, and an inner rubber layer 11b stacked on the inner side of the pulley contact-side surface layer 11a. Examples of the material that reduces the friction coefficient include short fibers such as nylon short fibers, vinylon short fibers, aramid short fibers, polyester short fibers, and cotton short fibers, ultra high molecular weight polyethylene resins, etc. It is preferable that the inner rubber layer 11b do not contain short fibers and the material that reduces the friction coefficient.

A powder layer 16 is combined and integrated with the compression rubber layer 11 so as to cover the surfaces of the V-shaped ribs 15, namely the pulley contact-side surface of the compression rubber layer 11 located on the side that is to contact the pulleys. The following problems occur in the case of spraying powder such as talc onto the surfaces of the V-shaped ribs after vulcanization-molding the V-ribbed belt. The powder adhering to the surfaces of the V-shaped ribs can fall off in a short time due to contact with the pulleys during running of the belt. In particular, if the V-ribbed belt is immersed in water when it rains, the powder can be very easily washed away by the water, whereby the abnormal-noise preventing effect of the powder may be eliminated. However, according to the V-ribbed belt B of the present embodiment, the powder layer 16 is provided so as to cover the surfaces of the V-shaped ribs 15 as the pulley contact-side surface of the compression rubber layer 11 in the V-ribbed belt body 10, and the power of the powder layer 16 is combined and integrated with the rubber composition forming the compression rubber layer 11 by a high temperature and a high pressure in the vulcanization-molding process. This can provide a long-term effect of suppressing a slip noise that is generated between the belt and the pulleys. Moreover, since the powder layer 16 also has the effect of reducing the friction coefficient, wear caused by contact with the pulleys can be suppressed. Moreover, concaves and convexes on the surface of the powder layer 16 can prevent hydroplaning (can drain water) upon immersion in water, and thus can prevent slipping due to immersion in water.

The powder layer 16 may be provided so as to cover the entire surfaces of the V-shaped ribs 16, namely the entire pulley contact-side surface. Alternatively, the powder layer 16 may be provided so as to partially cover the surfaces of the V-shaped ribs 15 as the pulley contact-side surface. For example, the powder layer 16 may be provided so as to cover only the surfaces of those V-shaped ribs 15 corresponding to half the circumference of the belt, or only the surfaces of those V-shaped ribs 15 located on the inner or outer side in the lateral direction of the belt. It is preferable that the powder forming the powder layer 16 be combined with the compression rubber layer 11 with part of the powder being buried in the compression rubber layer 11. The thickness of the powder layer 16 is preferably small enough to expose the rubber surface of the V-ribbed belt body 10. Specifically, the thickness of the powder layer 16 is preferably 0.1-200 μm, and more preferably 1.0-100 μm.

Examples of the powder forming the powder layer 16 include talc, calcium carbonate, silica, a layered silicate, etc. The powder may be comprised of either a single substance or a mixture of a plurality of substances. The particle size of the powder is preferably 0.1-150 μm, and more preferably 0.5-60 μm. As used herein, the “particle size” refers to a value represented by any of the mesh size of a test sieve as measured by a sieving method, the equivalent Stokes diameter as measured by a sedimentation method, the equivalent spherical diameter as measured by a light scattering method, and the equivalent spherical diameter as measured by an electrical resistance test method.

Examples of the layered silicate include a smectite group, a vermiculite group, and a kaolin group. The smectite group includes, e.g., montmorillonite, beidellite, saponite, hectorite, etc. The vermiculite group includes, e.g., trioctahedral vermiculite, dioctahedral vermiculite, etc. The kaolin group includes, e.g., kaolinite, dickite, halloysite, lizardite, amesite, chrysotile, etc. Montmorillonite of the smectite group is preferable as the layered silicate.

In order to increase wear resistance, it is preferable that a multiplicity of short fibers 17 be provided so that their tip ends protrude from the powder layer 16 provided so as to cover the surfaces of the V-shaped ribs 15 as the pulley contact-side surface of the compression rubber layer 11. The short fibers 17 preferably extend through the powder layer 16 with their base ends buried in the compression rubber layer 11 and their tip ends protruding from the surface of the powder layer 16.

Examples of the short fibers 17 include nylon short fibers, vinylon short fibers, aramid short fibers, polyester short fibers, and cotton short fibers. The short fibers 17 are manufactured by cutting long fibers along the longitudinal direction into pieces having a predetermined length. For example, the short fibers 17 are manufactured by subjecting fibers to an adhesion treatment of heating the fibers after soaking them in a resorcinol formaldehyde latex aqueous solution (hereinafter referred to as the “RFL aqueous solution”) etc. The short fibers 17 have a length of, e.g., 0.2-5.0 mm, and a diameter of, e.g., 10-50 μm.

The adhesion rubber layer 12 is formed in a band shape having a rectangular cross section that is longer in the horizontal direction than in the vertical direction, and has a thickness of, e.g., 1.0-2.5 mm. The backing rubber layer 13 is also formed in a band shape having a rectangular cross section that is longer in the horizontal direction than in the vertical direction, and has a thickness of, e.g., 0.4-0.8 mm. In order to suppress a noise that is generated between the backing rubber layer 13 and a flat pulley that is to contact the back face of the belt, the surface of the backing rubber layer 13 preferably has a weave pattern of woven fabric transferred thereto. Each of the adhesion rubber layer 12 and the backing rubber layer 13 is made of a rubber composition produced by kneading a mixture of a rubber component and various compounding agents to form an uncrosslinked rubber composition, heating and pressing the uncrosslinked rubber composition, and crosslinking the uncrosslinked rubber composition by a crosslinker. In order to suppress adhesion due to contact with a flat pulley that is to contact the back face of the belt, the backing rubber layer 13 is preferably made of a rubber composition that is slightly harder than that of the adhesion rubber layer 12. Note that the V-ribbed belt body 10 may be formed by the compression rubber layer 11 and the adhesion rubber layer 12, and for example, reinforcing fabric such as woven fabric, knit fabric, or nonwoven fabric formed by yarns of, e.g., cotton, polyamide fibers, polyester fibers, aramid fibers, etc. may be provided instead of the backing rubber layer 13.

Examples of the rubber component of the rubber composition that forms each of the adhesion rubber layer 12 and the backing rubber layer 13 include an ethylene-α-olefin elastomer, chloroprene rubber (CR), chlorosulfonated polyethylene rubber (CSM), hydrogenated acrylonitrile rubber (H-NBR), etc. The rubber component of the adhesion rubber layer 12 is preferably the same as that of the compression rubber layer 11.

As in the compression rubber layer 11, examples of the compounding agents include a reinforcer such as carbon black, a vulcanization accelerator, a crosslinker, an antioxidant, a softener, etc.

The compression rubber layer 11, the adhesion rubber layer 12, and the backing rubber layer 13 may be made of rubber compositions having different mixtures, respectively, or may be made of a rubber composition having the same mixture.

The core wire 14 is formed by twisted yarns such as polyester fibers (PET), polyethylene naphthalate fibers (PEN), aramid fibers, vinylon fibers, etc. In order to provide the core wire 14 with an adhesion property to the V-ribbed belt body 10, the core wire 14 is subjected to an adhesion treatment of heating the core wire 14 after soaking it in an RFL aqueous solution and/or an adhesion treatment of drying the core wire 14 after soaking it in rubber cement, before a molding process.

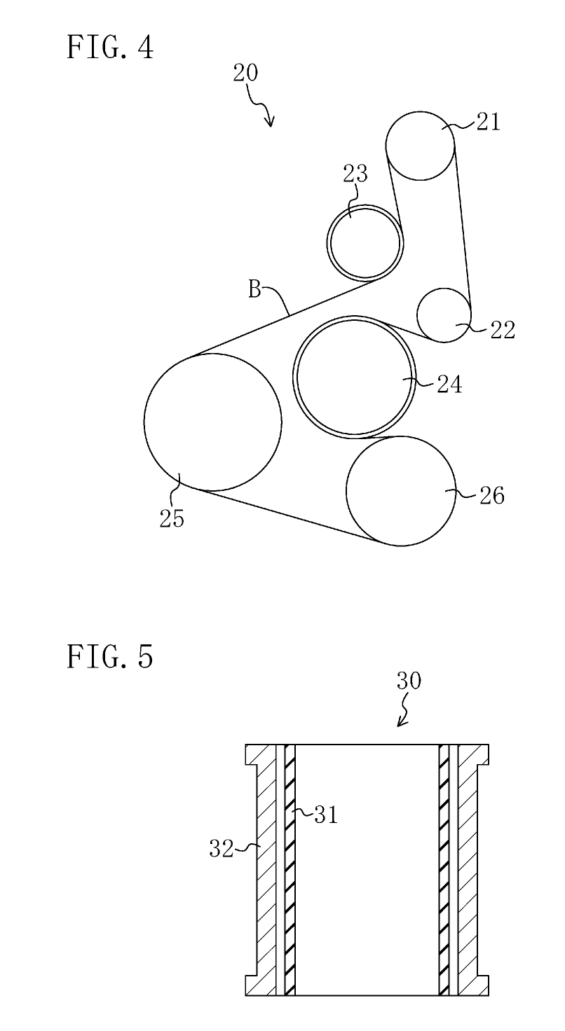

FIG. 4 shows a layout of pulleys of an accessory drive belt transmission system 20 of an automobile using the V-ribbed belt B of the present embodiment. This accessory drive belt transmission system 20 is of a serpentine drive type in which the V-ribbed belt B is wrapped around 6 pulleys, namely 4 ribbed pulleys and 2 flat pulleys, to transmit power.

This accessory drive belt transmission system 20 includes a power steering pulley 21 located at an uppermost position, an AC generator pulley 22 placed below the power steering pulley 21, a tensioner pulley 23 as a flat pulley placed on the lower left side of the power steering pulley 21, a water pump pulley 24 as a flat pulley placed below the tensioner pulley 23, a crankshaft pulley 25 placed on the lower left side of the tensioner pulley 23, and an air conditioner pulley 26 placed on the lower right side of the crankshaft pulley 25. All the pulleys except the tensioner pulley 23 and the water pump pulley 24 as the flat pulleys are ribbed pulleys. These ribbed and flat pulleys are formed by, e.g., pressing or casting of a metal, or resin molding of a nylon resin, a phenol resin, etc., and have a diameter of φ50-150 mm.

In this accessory drive belt transmission system 20, the V-ribbed belt B is wrapped first around the power steering pulley 21 with the side of the V-shaped ribs 15 being in contact therewith, next around the tensioner pulley 23 with the back face of the belt being in contact therewith, and then sequentially around the crankshaft pulley 25 and the air conditioner pulley 26 with the side of the V-shaped ribs 15 being in contact therewith. The V-ribbed belt B is further wrapped around the water pump pulley 24 with the back face of the belt being in contact therewith, and around the AC generator pulley 22 with the side of the V-shaped ribs 15 being in contact therewith, and finally returns to the power steering pulley 21. The belt span length, which is a length of the V-ribbed belt B between the pulleys, is, e.g., 50-300 mm. Misalignment between the pulleys is 0 to 2°.

In the case of spraying powder such as talc onto the surfaces of the V-shaped ribs after vulcanization-molding the V-ribbed belt, the powder adhering to the surfaces of the V-ribs falls off in a short time due to contact with the pulleys during running of the belt, and if the V-ribbed belt is immersed in water when it rains, the powder can be very easily washed away by the water, whereby the abnormal-noise preventing effect of the powder may be eliminated. However, according to this accessory drive belt transmission system 20, the powder layer 16 is combined and integrated so as to cover the surfaces of the V-shaped ribs 15 as the pulley contact-side surface of the compression rubber layer 11 in the V-ribbed belt body 11 of the V-ribbed belt B. This can provide a long-term effect of suppressing a slip noise that is generated between the belt and the ribbed pulleys such as the power steering pulley 21.

An example of a method for manufacturing the V-ribbed belt B according to the present embodiment will be described below with reference to FIGS. 5-10.

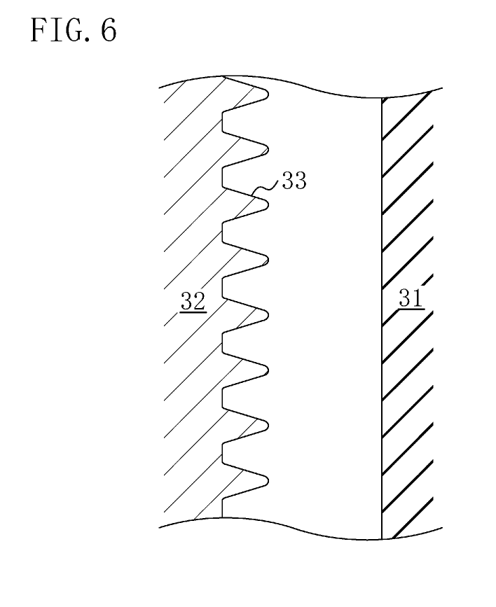

As shown in FIGS. 5-6, a belt forming mold 30 is used to manufacture the V-ribbed belt B according to the present embodiment. The belt forming mold 30 is formed by a cylindrical inner mold 31 (a rubber sleeve) and a cylindrical outer mold 32, which are provided concentrically.

In this belt forming mold 30, the inner mold 31 is made of a flexible material such as rubber. The outer peripheral surface of the inner mold 31 is formed as a molding surface, and a weave pattern of woven fabric etc. is formed in the outer peripheral surface of the inner mold 31. The outer mold 32 is made of a rigid material such as a metal. The inner peripheral surface of the outer mold 32 is formed as a molding surface, and grooves 33 for forming the V-shaped ribs are provided at a predetermined pitch on the inner peripheral surface of the outer mold 32. The outer mold 32 is provided with a temperature control mechanism that allows a heating medium such as water vapor or a cooling medium such as water to flow in the outer mold 32 to control the temperature. This belt forming mold 30 is provided with a pressing unit configured to pressing and expanding the inner mold 31 from the inside.

In manufacturing of the V-ribbed belt B according to the present embodiment, an uncrosslinked rubber sheet 11′ (an uncrosslinked rubber composition for forming a belt) for the compression rubber layer 11 is first fabricated by mixing each compounding agent with a rubber component, kneading the resultant mixture by a kneading machine such as a kneader, a Banbury mixer, etc., and molding the resultant uncrosslinked rubber composition into a sheet shape by calender molding etc. Similarly, uncrosslinked rubber sheets 12′, 13′ for the adhesion rubber layer 12 and the backing rubber layer 13 are also fabricated. Twisted yarns 14′ to be used as the core wire 14 are subjected to an adhesion treatment of heating the twisted yarns 14′ after soaking them in an RFL aqueous solution, and then to an adhesion treatment of heating and drying the twisted yarns 14′ after soaking them in rubber cement.

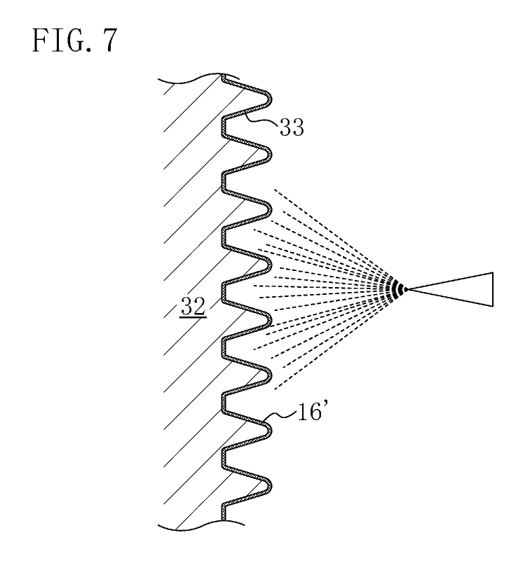

Then, as shown in FIG. 7, powder is sprayed onto the inner peripheral surface of the outer mold 32, namely the molding surface configured to form a pulley contact-side portion located on the side that is to contact the pulleys, thereby forming a layer 16′ of the powder. The thickness of the layer 16′ of the powder is preferably 0.1-200 μm, and more preferably 1.0-100 μm. At this time, in order to increase an adhesion property to the outer mold 32, the powder to be sprayed is preferably electrically charged by applying a voltage of, e.g., 10-100 kV. Note that the powder can be sprayed by using a common powder coating apparatus.

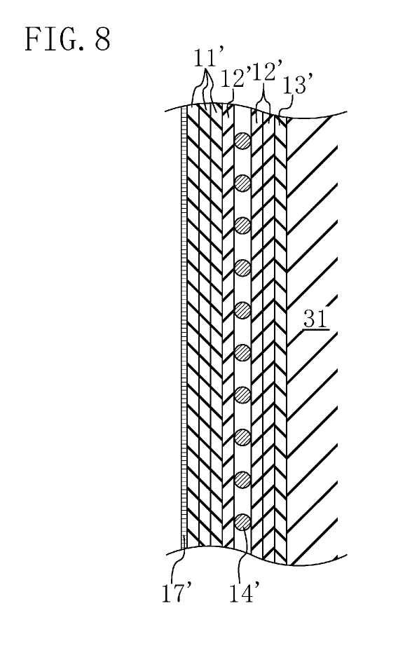

On the other hand, as shown in FIG. 8, the uncrosslinked rubber sheet 13′ for the backing rubber layer 13 and the uncrosslinked rubber sheet 12′ for the adhesion rubber layer 12 are sequentially wrapped around the outer peripheral surface of the inner mold 31 as the molding surface so as to be stacked thereon, and the twisted yarns 14′ for the core wire 14 are helically wound therearound over the cylindrical inner mold 31. Moreover, the uncrosslinked rubber sheet 12′ for the adhesion rubber layer 12 and the uncrosslinked rubber sheet 11′ for the compression rubber layer 11 are sequentially wrapped therearound so as to be stacked thereon. Note that in the case of manufacturing the V-ribbed belt B having such a configuration as shown in FIG. 3, different rubber compositions may be used for the pulley contact-side surface layer 11a and the inner rubber layer 11b as the uncrosslinked rubber sheet 11′ for the compression rubber layer 11.

In the case of exposing the short fibers 17 at the surfaces of the V-shaped ribs 15, an organic solvent such as toluene or an adhesive is applied to the outer peripheral surface of the outermost uncrosslinked rubber sheet 11′ for the compression rubber layer 11, and then the short fibers 17 are sprayed thereon to form a layer 17′ of the short fibers 17. The thickness of the layer 17′ of the short fibers 17 is preferably 10-300 μm, and more preferably 50-200 μm. Note that the short fibers may be sprayed by using a common spray-type short-fiber spraying apparatus such as that disclosed in Patent Document 4.

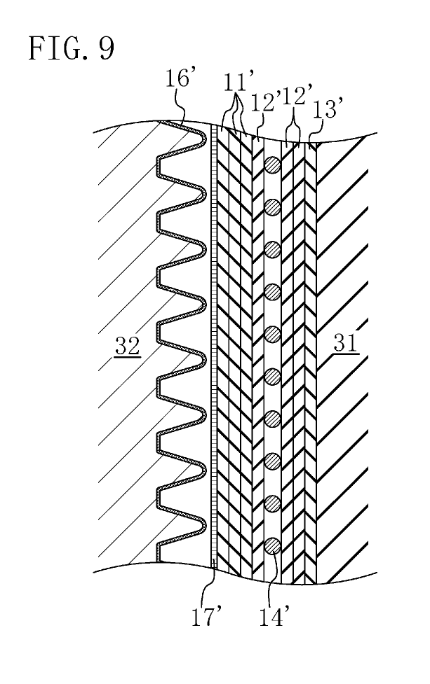

Then, as shown in FIG. 9, the inner mold 31 is positioned in the outer mold 32, and is sealed. At this time, the space inside the inner mold 31 is in a hermetically sealed state.

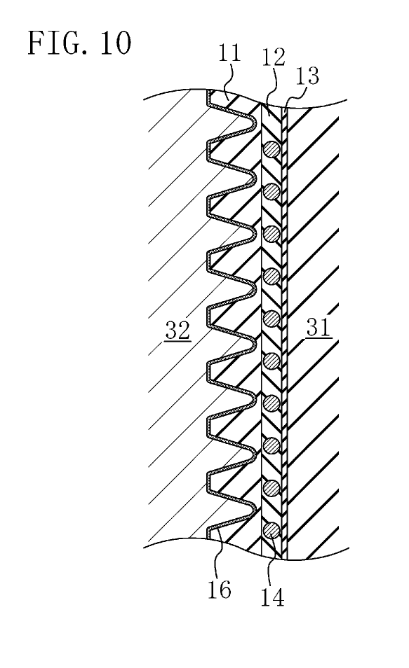

Subsequently, the outer mold 32 is heated, and high pressure air etc. is injected into the hermetically sealed space inside the inner mold 31 to pressurize the space. At this time, as shown in FIG. 10, the inner mold 31 is expanded, pressing the uncrosslinked rubber sheets 11, 12, 13 for forming the belt against the molding surface of the outer mold 32. Moreover, crosslinking of the uncrosslinked rubber sheets 11, 12, 13 proceeds, whereby the uncrosslinked rubber sheets 11, 12, 13 are integrated together and are combined with the twisted yarns 14. Thus, a cylindrical belt slab is finally molded. The layer 16′ of the powder provided in advance by spraying the powder onto the molding surface of the outer mold 32 is combined so as to cover the outer peripheral surface of the belt slab, forming the powder layer 16. The molding temperature of the belt slab is, e.g., 100-180° C., the molding pressure thereof is, e.g., 0.5-2.0 MPa, and the molding time is, e.g., 10 to 60 minutes.

Then, the space inside the inner mold 31 is reduced in pressure to be released from the hermetically sealed state, and the belt slab formed between the inner mold 31 and the outer mold 32 is removed. The belt slab is cut into rings having a predetermined width, and each ring is reversed, whereby the V-ribbed belt B is obtained.

Note that although the V-ribbed belt B is described as a friction drive belt in the present embodiment, the present invention is not particularly limited to this. The present invention is also applicable to a raw edge V-belt etc.

Although the accessory drive belt transmission system 20 of an automobile is described as the belt transmission system in the present embodiment, the present invention is not particularly limited to this. The present invention is also applicable to general industrial belt transmission systems etc.

### EXAMPLES

### V-Ribbed Belt

### Example 1

Respective uncrosslinked rubber sheets for the compression rubber layer, the adhesion rubber layer, and the backing rubber layer, each made of an EPDM composition, and twisted yarns for the core wire were prepared.

Specifically, the uncrosslinked rubber sheet for the pulley contact-side surface layer of the compression rubber layer was produced by mixing 100 parts by mass of EPDM (made by The Dow Chemical Company, trade name: Nordel IP4640, ethylene content: 55% by mass, propylene content: 40% by mass, ethylidene norbomane (ENB): 5.0% by mass, Mooney viscosity: 40 ML₁₊₄ (125° C.)) as a rubber component with 50 parts by mass of carbon black (made by Showa Cabot Corp., trade name: Showblack IP200 Carbon), 8 parts by mass of paraffinic oil (made by Japan Sun Oil Company LTD., trade name: SunFlex 2280), 1.6 parts by mass of a vulcanizing agent (made by Hosoi Chemical Industry Co., Ltd., trade name: Oil Sulfur), 2.8 parts by mass of a vulcanization accelerator (made by Ouchi Shinko Chemical Industrial Co., Ltd., trade name: EP-150), 1.2 parts by mass of a vulcanization accelerator (made by Ouchi Shinko Chemical Industrial Co., Ltd., trade name: MSA), 1 part by mass of a vulcanization assistant (made by Kao Corporation, stearic acid), 5 parts by mass of a vulcanization assistant (made by Sakai Chemical Industry Co., Ltd., zinc oxide), 2 parts by mass of an antioxidant (made by Ouchi Shinko Chemical Industrial Co., Ltd., trade name: 224), 1 part by mass of an antioxidant (made by Ouchi Shinko Chemical Industrial Co., Ltd., trade name: MB), and 40 parts by mass of ultra high molecular weight polyethylene (Mitsui Chemicals, Inc., trade name: Hizex Million 240S), kneading the mixture in a Banbury mixer, and then rolling the kneaded mixture by calender rolls.

The uncrosslinked rubber sheet for the inner rubber layer of the compression rubber layer was produced by mixing 100 parts by mass of EPDM (made by The Dow Chemical Company, trade name: Nordel IP4640) as a rubber component with 70 parts by mass of carbon black (made by Showa Cabot Corp., trade name: Showblack IP200 Carbon), 8 parts by mass of paraffinic oil (made by Japan Sun Oil Company LTD., trade name: SunFlex 2280), 1.6 parts by mass of a vulcanizing agent (made by Hosoi Chemical Industry Co., Ltd., trade name: Oil Sulfur), 2.8 parts by mass of a vulcanization accelerator (made by Ouchi Shinko Chemical Industrial Co., Ltd., trade name: EP-150 (a mixture of vulcanization accelerators DM (dibenzothiazyl disulfide), TT (tetramethylthiuramdisulfide), and EZ (zinc diethyldithiocarbamate)), 1.2 parts by mass of a vulcanization accelerator (made by Ouchi Shinko Chemical Industrial Co., Ltd., trade name: MSA (N-oxydiethylene-2-benzothiazolylsulfenamide), 1 part by mass of a vulcanization assistant (made by Kao Corporation, stearic acid), 5 parts by mass of a vulcanization assistant (made by Sakai Chemical Industry Co., Ltd., zinc oxide), 2 parts by mass of an antioxidant (made by Ouchi Shinko Chemical Industrial Co., Ltd., trade name: 224 (TMDQ: 2,2,4-trimethyl-1,2-dihydroquinoline)), and 1 part by mass of an antioxidant (made by Ouchi Shinko Chemical Industrial Co., Ltd., trade name: MB (2-mercaptobenzimidazole)), kneading the mixture in a Banbury mixer, and then rolling the kneaded mixture by calender rolls.

The uncrosslinked rubber sheet for the adhesion rubber layer was produced by mixing 100 parts by mass of EPDM (made by The Dow Chemical Company, trade name: Nordel IP4640) as a rubber component with 50 parts by mass of carbon black (made by Mitsubishi Chemical Corporation, trade name: HAF Carbon), 20 parts by mass of silica (made by Tokuyama Corporation, trade name: TOKUSIL Gu), 20 parts by mass of paraffinic oil (made by Japan Sun Oil Company LTD., trade name: SunFlex 2280), 3 parts by mass of a vulcanizing agent (made by Hosoi Chemical Industry Co., Ltd., trade name: Oil Sulfur), 2.5 parts by mass of a vulcanization accelerator (made by Ouchi Shinko Chemical Industrial Co., Ltd., trade name: EP-150), 1 part by mass of a vulcanization assistant (made by Kao Corporation, stearic acid), 5 parts by mass of a vulcanization assistant (made by Sakai Chemical Industry Co., Ltd., zinc oxide), 2 parts by mass of an antioxidant (made by Ouchi Shinko Chemical Industrial Co., Ltd., trade name: 224), 1 part by mass of an antioxidant (made by Ouchi Shinko Chemical Industrial Co., Ltd., trade name: MB), 5 parts by mass of a tackifier (ZEON CORPORATION, trade name: Petroleum Resin Quintone A100), and 2 parts by mass of short fibers (cotton powder), kneading the mixture in a Banbury mixer, and then rolling the kneaded mixture by calender rolls.

The uncrosslinked rubber sheet for the backing rubber layer was produced by mixing 100 parts by mass of EPDM (made by The Dow Chemical Company, trade name: Nordel IP4640) as a rubber component with 60 parts by mass of carbon black (made by Mitsubishi Chemical Corporation, trade name: HAF Carbon), 8 parts by mass of paraffinic oil (made by Japan Sun Oil Company LTD., trade name: SunFlex 2280), 1.6 parts by mass of a vulcanizing agent (made by Hosoi Chemical Industry Co., Ltd., trade name: Oil Sulfur), 2.8 parts by mass of a vulcanization accelerator (made by Ouchi Shinko Chemical Industrial Co., Ltd., trade name: EP-150), 1.2 part by mass of a vulcanization accelerator (made by Ouchi Shinko Chemical Industrial Co., Ltd., trade name: MSA), 1 part by mass of a vulcanization assistant (made by Kao Corporation, stearic acid), 5 parts by mass of a vulcanization assistant (made by Sakai Chemical Industry Co., Ltd., zinc oxide), 2 parts by mass of an antioxidant (made by Ouchi Shinko Chemical Industrial Co., Ltd., trade name: 224), 1 part by mass of an antioxidant (made by Ouchi Shinko Chemical Industrial Co., Ltd., trade name: MB), and 13 parts by mass of short fibers (made by Asahi Kasei Corporation, trade name: Nylon 66, Type T-5), kneading the mixture in a Banbury mixer, and then rolling the kneaded mixture by calender rolls.

The twisted yarns for the core wire are made of 1,100 dtex/2×3 (the number of second twists: 9.5 T/10 cm (Z), the number of first twists: 2.19 T/10 cm) of polyester fibers made by TEIJIN LIMITED. These twisted yarns were sequentially subjected to a treatment of heating and drying the twisted yarns at 240° C. for 40 seconds after soaking them in a toluene solution containing 20% by mass (solid content) of isocyanate, a treatment of heating and drying the twisted yarns at 200° C. for 80 seconds after soaking them in an RFL aqueous solution, and a treatment of heating and drying the twisted yarns at 60° C. for 40 seconds after soaking them in rubber cement produced by dissolving a rubber composition for the adhesion rubber layer in toluene.

Note that the RFL aqueous solution was prepared as follows. Resorcinol, formalin (37% by mass), and sodium hydroxide were added to water, and the resultant mixture was stirred. Then, water was added to the mixture, and the resultant mixture was matured for 5 hours while stirring, thereby preparing an RF aqueous solution with the ratio of the number of moles of resorcinol (R) to the number of moles of formalin (F) being 0.5. 40% by mass (solid content) of chlorosulfonated polyethylene rubber (CSM) latex (L) was added to this RF aqueous solution so that the solid mass ratio of RF to L become 0.25, and water was further added so that the solid content become 20% by mass. The resultant mixture was matured for 12 hours while stirring, whereby the RFL aqueous solution was prepared.

A rubber sleeve was placed on a cylindrical drum having a smooth surface, and the uncrosslinked rubber sheet for the backing rubber layer and the uncrosslinked rubber sheet for the adhesion rubber layer were sequentially wrapped around the rubber sleeve. Then, the twisted yarns having subjected to an adhesion treatment were helically wound therearound. Moreover, the uncrosslinked rubber sheet for the adhesion rubber layer, the uncrosslinked rubber sheet for the pulley contact-side surface layer of the compression rubber layer, and the uncrosslinked rubber sheet for the inner rubber layer of the compression rubber layer were sequentially wrapped therearound, thereby forming a stack on the rubber sleeve. After toluene was applied to the outer peripheral surface of the stack, nylon short fibers (made by Rhodia, trade name: Rhodia SD, fiber length: 0 6 mm) were sprayed thereto to form a layer of the short fibers.

On the other hand, talc powder (made by FUJI TALC INDUSTRIAL CO., LTD., trade name: DS-34, particle size: 20 μm) electrically charged at 100 kV was sprayed to the inner peripheral surface of the outer mold to form a powder layer. The stack was placed thereon, and the outer mold was placed over the inner mold to seal the inner mold.

Then, the outer mold was heated, and the hermetically sealed space inside the inner mold was pressured to vulcanization-mold a belt slab. The molding temperature was 170° C., the molding pressure was 1.0 MPa, and the molding time was 30 minutes.

V-ribbed belts manufactured from this belt slab were used as Example 1. V-ribbed belts having three ribs (belt width: 10.68 mm) and six ribs (belt width: 21.36 mm), respectively, were fabricated as the V-ribbed belts of Example 1. Note that each V-ribbed belt had a circumference of 1,115 mm and a thickness of 4.3 mm, and had V-shaped ribs having a height of 2.0 mm.

### Example 2

In Example 2, V-ribbed belts were manufactured by the same method as Example 1 except that spraying of short fibers was not performed.

### Comparative Example 1

In Comparative Example 1, V-ribbed belts were manufactured by the same method as Example 1 except that spraying of powder was not performed. Powder was sprayed to the surfaces of the V-shaped ribs after performing vulcanization-molding.

### Comparative Example 2

In Comparative Example 2, V-ribbed belts were manufactured by the same method as Example 1 except that spraying of powder was not performed.

### Comparative Example 3

In Comparative Example 3, V-ribbed belts were manufactured by the same method as Comparative Example 2 except that the layer of short fibers was formed by spraying short fibers to the inner peripheral surface of the outer mold after applying a urethane adhesive thereto, instead of spraying short fibers to the outer peripheral surface of the outermost uncrosslinked rubber sheet for the compression rubber layer provided over the inner mold.

### Comparative Example 4

In Comparative Example 4, V-ribbed belts were manufactured by the same method as Comparative Example 2 except that the layer of short fibers was formed by spraying short fibers to the outer peripheral surface of the outermost uncrosslinked rubber sheet for the compression rubber layer provided over the inner mold, after applying a urethane adhesive thereto.

### Comparative Example 5

In Comparative Example 5, V-ribbed belts were manufactured by the same method as Example 1 except that spraying of powder and short fibers was not performed. Short fibers were sprayed to the surfaces of the V-shaped ribs after applying an adhesive thereto.

(Test Evaluation Method)

<Belt Durability Test>

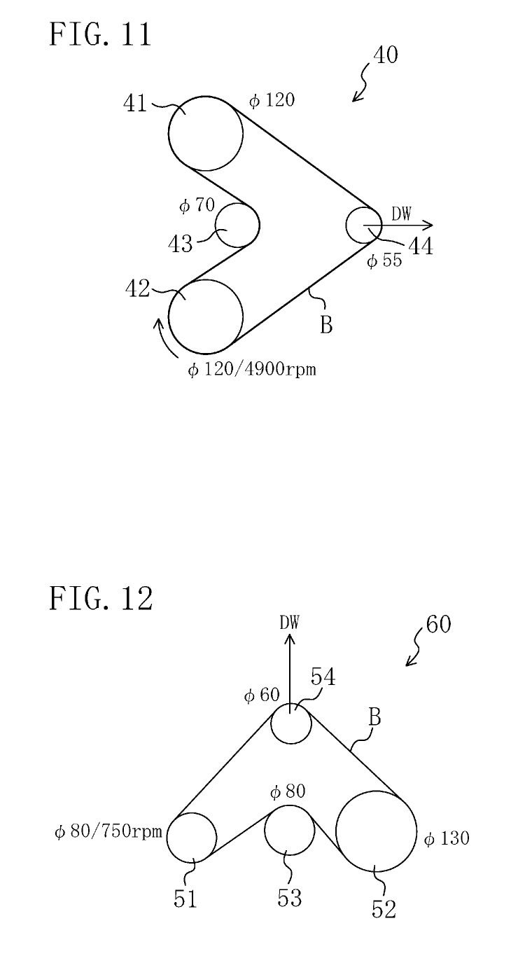

FIG. 11 shows a layout of pulleys of a belt running tester 40 for a belt durability test.

In this belt running tester 40, a large-diameter driven pulley 41 and a driving pulley 42 as ribbed pulleys having a diameter of 120 mm are arranged so as to be spaced apart from each other in the vertical direction. An idler pulley 43 as a flat pulley having a diameter of 70 mm is provided at an intermediate position in the vertical direction between the large-diameter driven pulley 41 and the driving pulley 42, and a small-diameter driven pulley 44 as a ribbed pulley having a diameter of 45 mm is provided on the right side of the idler pulley 43. This belt running tester 40 is configured so that the V-ribbed belt B is wrapped around these pulleys with the V-shaped ribs of the V-ribbed belt B being in contact with the large-diameter driven pulley 41, the driving pulley 42, and the small-diameter driven pulley 44 as ribbed pulleys, and with the back side of the V-ribbed belt B being in contact with the idler pulley 43 as a flat pulley. Note that the idler pulley 43 and the small-diameter driven pulley 44 are positioned so that the wrap-around angle of the V-ribbed belt B is 90°. The small-diameter driven pulley 44 is configured to be movable in the lateral direction so that a tensile force can be applied to the V-ribbed belt B.

Each of those V-ribbed belts of Examples 1-2 and Comparative Examples 1-5 having three ribs was placed on the belt running tester 40. Rotation load of 11.8 kW was applied to the large-diameter driven pulley 41, and a dead weight of 686 N was laterally applied to the small-diameter driven pulley 44 so that a tensile force is applied to the V-ribbed belt. The driving pulley 42 was rotated at a rotational speed of 4,900 rpm at an ambient temperature of 120° C. to cause the belt to run. The running time until cracks appeared in the compression rubber layer of the V-ribbed belt B and reached the core wire was measured as “durable running time.”

<Noise Test during Running of Belt>

FIG. 12 shows a layout of pulleys of a belt running tester 50 for a noise test during running of the belt.

In the belt running tester 50, a driving pulley 51 as a ribbed pulley having a diameter of 80 mm is provided at a lower left position, and a first driven pulley 52 as a ribbed pulley made of a phenol resin and having a diameter of 130 mm is provided on the right side of the driving pulley 51. A second driven pulley 53 as a flat pulley having a diameter of 80 mm is provided between the driving pulley 51 and the first driven pulley 52, and a third driven pulley 54 as a ribbed pulley having a diameter of 60 mm is provided above the second driven pulley 53. The belt running tester 50 is configured so that the V-ribbed belt B is wrapped around these pulleys with the V-shaped ribs of the V-ribbed belt B being in contact with the driving pulley 51, the first driven pulley 52, and the third driven pulley 54 as ribbed pulleys, and with the back side of the V-ribbed belt B being in contact with the second driven pulley 53 as a flat pulley. Note that the third driven pulley 54 is configured to be movable in the vertical direction so that a tensile force can be applied to the V-ribbed belt B. A misalignment of 3° is provided between the first driven pulley 52 and the second driven pulley 53.

Each of those V-ribbed belts of Examples 1-2 and Comparative Examples 1-5 having six ribs was placed on the belt running tester 50. A dead weight of 380 N was applied upward to the third driven pulley 54 so that a tensile force is applied to the V-ribbed belt. The driving pulley 51 was rotated at a rotational speed of 750 rpm at an ambient temperature of 5° C. to cause the belt to run. The running time of the belt until a specific abnormal noise was generated was measured as “noise generation running time.” Note that the test was stopped when the running time of the belt exceeded 500 hours.

(Test Evaluation Result)

Table 1 shows the test result.

TABLE 1

| | | | Durable | Noise Generation |
|---|---|---|---|---|
| | Powder | Short Fibers | Running Time | Running Time |
| Example 1 | Spray to outer mold | Spray to rubber | 794 h | Over 500 h |
| | before molding | before molding | | |
| Example 2 | Spray to outer mold | — | 817 h | 488 h |
| | before molding | | | |
| Comparative Example 1 | Spray to belt | Spray to rubber | 882 h | 3 h |
| | after molding | before molding | | |
| Comparative Example 2 | — | Spray to rubber | 752 h | 0 h |
| | | before molding | | |
| Comparative Example 3 | — | Spray to outer mold | 367 h | 104 h |
| | | before molding | | |
| | | (with adhesive) | | |
| Comparative Example 4 | — | Spray to rubber | 214 h | 154 h |
| | | before molding | | |
| | | (with adhesive) | | |
| Comparative Example 5 | — | Spray to belt | 98 h | 237 h |
| | | after molding | | |
| | | (with adhesive) | | |

The durable running time was as follows. Example 1: 794 hours, Example 2: 817 hours, Comparative Example 1: 882 hours, Comparative Example 2: 752 hours, Comparative Example 3: 367 hours, Comparative Example 4: 214 hours, and Comparative Example 5: 98 hours. Cracks in the adhesive were also observed in Comparative Examples 4 and 5.

The noise generation running time was as follows. Example 1: the test was stopped as the running time exceeded 500 hours, Example 2: 488 hours, Comparative Example 1: 3 hours, Comparative Example 2: 0 hours (the noise was generated during the initial period of running), Comparative Example 3: 104 hours, Comparative Example 4: 154 hours, and Comparative Example 5: 237 hours. Upon generation of the noise, no powder was observed on the surfaces of the V-shaped ribs in Comparative Example 1, and no short fiber was observed on the surfaces of the V-shaped ribs in Comparative Examples 4-5.

### INDUSTRIAL APPLICABILITY

The present invention is useful for friction drive belts in which a belt body made of a rubber composition is wrapped around pulleys to transmit power, and manufacturing methods thereof, and belt transmission systems using the same.

### Description of Reference Characters

B V-Ribbed Belt (Friction Drive Belt)

10 V-Ribbed Belt Body

11 Compression Rubber Layer

11a Pulley Contact-Side Surface Layer

11b Inner Rubber Layer

11′ Uncrosslinked Rubber Sheet (Uncrosslinked Rubber Composition for Forming Belt) for Compression Rubber Layer

16 Powder Layer

16′ Layer of Powder

17 Short Fibers

17′ Layer of Short Fibers

30 Belt Forming Mold

1-15. (canceled)

16. A friction drive belt, comprising:
a belt body that is made of a rubber composition and is wrapped around pulleys to transmit power; and
a powder layer is combined and integrated with a pulley contact-side surface of the belt body so that the powder layer covers the pulley contact-side surface.

17. A friction drive belt, comprising:
a belt body that is made of a rubber composition and is wrapped around pulleys to transmit power, wherein
the friction drive belt is manufactured by providing a layer of powder by spraying, in advance, powder to a molding surface of a belt forming mold which is configured to form a pulley contact-side portion, pressing against the molding surface an uncrosslinked rubber composition configured to form the belt, and thus crosslinking the uncrosslinked rubber composition.

18. The friction drive belt of claim 16, wherein
the powder layer is provided so as to cover the entire pulley contact-side surface.

19. The friction drive belt of claim 16, wherein
the powder layer is provided so as to partially cover the pulley contact-side surface.

20. The friction drive belt of claim 16, wherein
part of the powder forming the powder layer is buried in the rubber composition forming the belt body.

21. The friction drive belt of claim 16, wherein
the powder layer has a thickness of 0.1-200 μm.

22. The friction drive belt of claim 16, wherein
the powder forming the powder layer includes at least one of talc, calcium carbonate, silica, and a layered silicate.

23. The friction drive belt of claim 16, wherein
the powder forming the powder layer has a particle size of 0.1-150 μm.

24. The friction drive belt of claim 16, wherein
a multiplicity of short fibers are provided so that their tip ends protrude from the powder layer provided so as to cover the pulley contact-side surface.

25. The friction drive belt of claim 16, wherein
the belt body has a pulley contact-side surface layer containing a material that reduces a friction coefficient, and an inner rubber layer stacked on an inner side of the pulley contact-side surface layer.

26. A belt transmission system, comprising:
the friction drive belt of claim 16 wrapped around a plurality of pulleys.

27. The belt transmission system of claim 26, wherein
the belt transmission system is an accessory drive belt transmission system for an automobile.

28. A method for manufacturing a friction drive belt, comprising:
pressing an uncrosslinked rubber composition configured to form the belt, against a molding surface of a belt forming mold which is configured to form a pulley contact-side portion, and thus crosslinking the uncrosslinked rubber composition; and
before pressing against the molding surface of the belt forming mold the uncrosslinked rubber composition configured to form the belt, providing a layer of powder by spraying, in advance, powder to the molding surface of the belt forming mold.

29. The method of claim 28, wherein
the powder that is sprayed to the molding surface of the belt forming mold is electrically charged.

30. The method of claim 28, further comprising:
before pressing against the molding surface the uncrosslinked rubber composition configured to form the belt, providing a layer of short fibers by spraying, in advance, short fibers to a surface of the uncrosslinked rubber composition.

31. The method of claim 29, further comprising:
before pressing against the molding surface the uncrosslinked rubber composition configured to form the belt, providing a layer of short fibers by spraying, in advance, short fibers to a surface of the uncrosslinked rubber composition.
